(19) United States
(12) Patent Application Publication
(10) Pub. No.: US 2020/0217406 A1
(43) Pub. Date: Jul. 9, 2020

(54) RACK STRUCTURE, GEAR AND GEAR TRANSMISSION MECHANISM HAVING THE SAME

(71) Applicant: SUZHOU INDUSTRY PARK KAYMAX PRECISION ENGINEERING CO., LTD., Suzhou City, Jiangsu Province (CN)

(72) Inventor: JIAN JIANG, Suzhou City, Jiangsu Province (CN)

(21) Appl. No.: 16/647,479

(22) PCT Filed: Sep. 5, 2018
(86) PCT No.: PCT/CN2018/104139

§ 371 Date: Mar. 13, 2020

(30) Foreign Application Priority Data
Sep. 13, 2017 (CN) 201710819807.1

(51) Int. Cl. F16H 55/17; F16H 55/26

(52) U.S. Cl. CPC F16H 55/17; F16H 55/12; F16H 55/26

(57) ABSTRACT

The present invention discloses a rack structure, a gear and a gear transmission mechanism having the same. The rack structure comprises a rack body, a plurality of teeth formed on an outer side of the rack body, and an engaging portion formed on an inner side of the rack body, the engaging portion being shaped to engage with a connecting portion at an outer edge of the gear base; the rack structure is detachably mounted on the gear base through engagement or disengagement of the engaging portion and the connecting portion. The rack structure can be directly detachably mounted on the gear base through engagement and disengagement of the engaging portion and the connecting portion on the gear base, so that the rack structure can be assembled quickly. Once the teeth on the rack structure wear, it is feasible to replace the rack structure, without replacing the gear base.

The present application claims priority of Chinese Patent Application No. 201710819807.1, filed on Sep. 13, 2017 and titled “Rack Structure, Gear and Gear Transmission Mechanism Having the Same”, the content of which is incorporated herein by reference in its entirety.

### TECHNICAL FIELD

The present invention relates to the technical field of a reduction transmission structure, and particularly relates to a rack structure, a gear and a gear transmission mechanism having the same.

### BACKGROUND

A conventional gear transmission structure is generally made of a metallic material. However, since the metallic material is high in cost and heavy in weight, the gear employs some light-weighted materials such as plastic to reduce the cost. However, since the light-weighted materials are generally injection molded or formed by printing, an engaging tooth portion of such gear is extremely prone to wear, and the whole engaging tooth and its corresponding gear base need to be scrapped after the wear, and that causes the service life of the whole gear become shorter. Furthermore, replacement of the gear base is time-consuming and laborious and hinders normal production of the whole production line.

### SUMMARY

An object of the present invention is to provide a rack structure, a gear and a gear transmission mechanism having the same.

In order to achieve the above object, the present invention provides a rack structure, wherein the rack structure comprises a rack body, a plurality of teeth formed on an outer side of the rack body, and an engaging portion formed on an inner side of the rack body, the engaging portion being shaped to engage with a connecting portion at an outer edge of the gear base; the rack structure is detachably mounted on the gear base through engagement or disengagement of the engaging portion and the connecting portion.

As a further improvement of the present invention, the engaging portion is configured as a plurality of protrusions spaced apart from one another, and the connecting portion is configured as grooves disposed at positions corresponding to the protrusions; when the rack structure is mounted on the gear base, the protrusions are snap-fitted into the grooves.

As a further improvement of the present invention, wherein the rack structure is configured as a circular arc shape, and disposed around partial outer edge of the gear base.

As a further improvement of the present invention, the rack structure is configured as a circular ring shape, and disposed around the whole outer edge of the gear base.

As a further improvement of the present invention, a surface of the rack body which adjacent to the engaging portion is provided circumferentially with a first vent structure, and the first vent structure comprises a plurality of discontinuous first vents.

As a further improvement of the present invention, the shape of the vents is configured as one of a circle, a rectangle, an arc, an oval shape and a profiled shape.

As a further improvement of the present invention, several layers of the first vent structures are arranged in a radial direction of the rack body toward the engaging portion.

Another embodiment of the present invention provides a gear, wherein the gear comprises a gear base and the rack structure as mentioned above.

As a further improvement of the present invention, a surface of the gear base which adjacent to the connection portion is provided circumferentially with a second vent structure, and the second vent structure includes a plurality of discontinuous second vents.

Another embodiment of the present invention provides a gear transmission mechanism, wherein the gear transmission mechanism comprises a first gear and a second gear which mesh each other, and one of the first gear or second gear is the gear as mentioned above.

As compared with the prior art, the rack structure provided by the present invention can be directly detachably mounted on the gear base through engagement and disengagement of the engaging portion and the connecting portion on the gear base, so that the rack structure can be assembled quickly. Once the teeth on the rack structure wear, it is feasible to directly replace the rack structure, without replacing the gear base, thereby ensuring normal production of the production line and guaranteeing the service life of the whole gear base.

### BRIEF DESCRIPTION OF THE DRAWINGS

FIG. 1 is a structural schematic diagram of a gear in an embodiment of the present invention;

FIG. 2 is a structural schematic diagram of a rack structure in an embodiment of the present invention;

FIG. 3 is a structural schematic diagram of a rack structure in another embodiment of the present invention;

FIG. 4 is a structural schematic diagram of a gear in an embodiment of the present invention;

FIG. 5 is a structural schematic diagram of a gear in an embodiment of the present invention.

### DETAILED DESCRIPTION

The present invention will be described in detail below in conjunction with various embodiments shown in the drawings. However, these embodiments do not limit the present invention, and structural or functional changes made by an ordinary person skilled in the art based on these embodiments are included in the protection scope of the present invention.

It should be understood that the terms expressive of spatial relative positions, such as “upper”, “above”, “lower”, “below”, or the like herein are used to describe the relationship of a unit or feature relative to another unit or feature in the drawings, for the purpose of illustration and description. Terms expressive of the spatial relative positions are intended to include different orientations of the device in use or operation other than the orientations shown in the drawings.

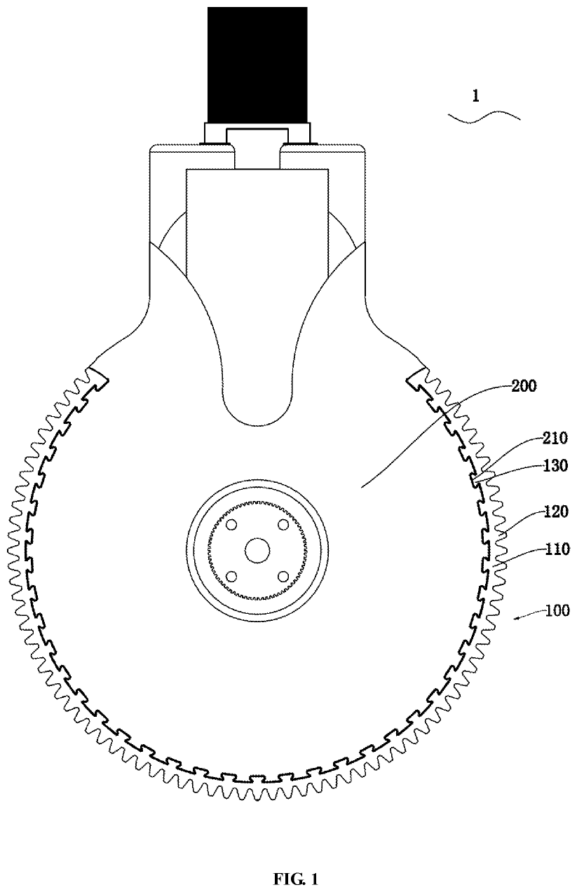

As shown in FIGS. 1-5, embodiments of the present invention are introduced. As shown in FIG. 1, an embodiment of the present invention discloses a gear 1 comprising a gear base 200 and a rack structure 100. In the present embodiment, the rack structure 100 comprises a rack body 110, a plurality of teeth 120 formed on an outer side of the rack body 110, and an engaging portion 130 formed on an inner side of the rack body 110, and the engaging portion 130 is shaped to engage with a connecting portion 210 at an outer edge of the gear base 200; the rack structure 100 is detachably mounted on the gear base 200 through engagement or disengagement of the engaging portion 130 and the connecting portion 210.

The rack structure 100 provided by the present invention can be directly detachably mounted on the gear base 200 through engagement and disengagement of the engaging portion 130 and the connecting portion 210 on the gear base 200, so that the rack structure 100 can be assembled quickly. Once the teeth on the rack structure 100 wear, it is feasible to directly replace the rack structure, without replacing the gear base, thereby ensuring normal production of the production line and guaranteeing the service life of the whole gear base.

Furthermore, since the rack structure 100 is detachable, a lighter material or structure without a high requirement for the wear resistance can be selected to make the gear base 200, which can reduce the weight of the whole gear transmission mechanism and meanwhile cannot reduce its transmission capability.

Furthermore, the engaging portion 130 is configured as a plurality of protrusions spaced apart from one another, and the connecting portion 210 is configured as grooves disposed at positions corresponding to the protrusions; when the rack structure 100 is mounted on the gear base 200, the protrusions are snap-fitted into the grooves. The plurality of protrusions spaced apart from one another are evenly formed on the inner side of the rack body 110, and a plurality of grooves are evenly formed on the outer edge of the gear base 200 at positions corresponding to the protrusions. The protrusions on the rack structure 100 tightly engage with the grooves on the gear base 200, thereby ensuring no occurrence of displacement during transmission and ensuring normal operation of the whole structure.

In another embodiment, it is also possible that the engaging portion is a plurality of grooves spaced apart from one another whereas the connecting portion is protrusions at positions corresponding to the grooves; when the rack structure is mounted on the gear base, the protrusions snap-fit with the grooves.

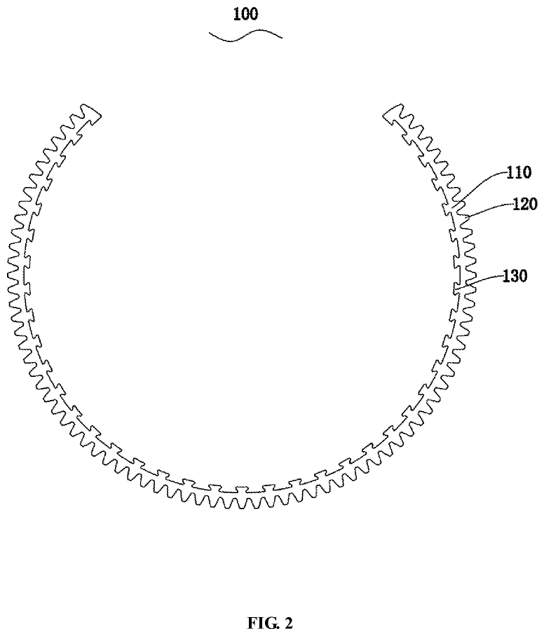

Preferably, as shown in FIG. 2, the rack structure 100 is configured as a circular arc shape. The circular arc-shaped rack structure 100 is disposed around partial outer edge of the gear base 200.

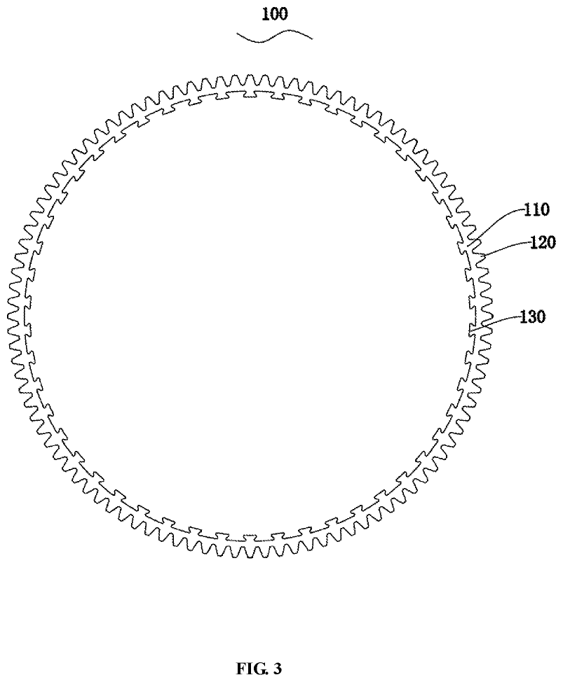

As shown in FIG. 3, the rack structure 100 can be configured as a circular ring shape. The circular ring-shaped rack structure 100 is disposed around the whole outer edge of the gear base 200.

The rack structure 100 can be set to have a circular arc shape or circular ring shape to suit different use scenarios.

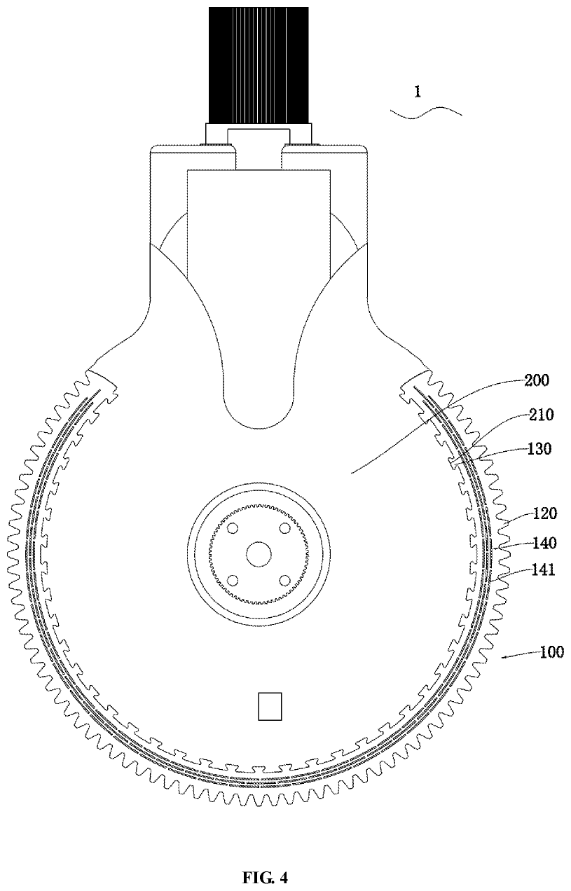

Furthermore, as shown in FIG. 4, a surface of the rack body 110 which adjacent to the engaging portion 130 is provided circumferentially with a first vent structure 140, and the first vent structure 140 includes a plurality of discontinuous first vents 141.

The shape of the first vents 141 can be configured as any one of a circle, a rectangle, an arc, an oval shape or a profiled shape. Specifically, the profiled shape refers to an irregular closed shape, such as an asymmetric closed shape, or a closed shape with four sides which are different in length and not parallel to one another, and other irregular cases, which are not limited in the embodiments of the present invention. In the present embodiment, the first vent 141 is rectangular.

Furthermore, several layers of first vent structures 140 can be arranged in a radial direction of the rack body 110 toward the engaging portion 130. In the present embodiment, the first vent structure 140 is preferably a three-layer arrangement structure, which ensures the size for mutual pressure when the gears mesh, and ensures smooth transmission.

In the embodiment of the present invention, the first vents 141 in adjacent layers of the first vent structures 140 can be staggered. The staggered first vents 141 can make the rack structure 100 more stable.

Preferably, each of the first vents 141 penetrates the rack body 110 in a thickness direction of the rack body 110. In another embodiment, the first vent can also be a blind hole provided on the rack body and does not penetrate the rack body.

In the present embodiment, as shown in FIG. 4, the rack structure 100 is made of a flexible material, and the first vent structure is provided on the rack structure 100 made of the flexible material and mainly functions to ensure stability of meshing transmission even in a case where the precision of the gears in the gear transmission mechanism is not high. Specifically, the gear transmission mechanism (not shown) generally includes a first gear and a second gear that mesh with each other. One of the first gear and the second gear can be gear 1, or both of them can be gear 1. For example, in the case where the first gear is gear 1, when the second gear meshes with the first gear, while the teeth on the second gear mesh with tooth grooves on the first gear at corresponding positions, the teeth of the second gear will press the first vent structure 140 on the rack structure 100 because the rack structure 100 is made of the flexible material, thereby ensuring the stability of the meshing. In a case where the teeth on the second gear and teeth on the first gear do not have a high precision or do not precisely correspond to one another upon meshed connection, since the first vent structure 140 can be pressed upon meshing, a stable pressed state can be always maintained between the first gear and the second gear, and the stability and accuracy of the gear transmission can be ensured.

Specifically, a meshing radial length of the first gear and the second gear can be set to be slightly larger than a distance between the two transmission shafts, and a distance difference is generated between the two. When the first gear meshes with the second gear, the teeth on the second gear will press the first vent structure 140 on the first gear, so that a compression distance of the first vent structure 140 can offset the above-mentioned distance difference, thereby ensuring the stability of the meshing.

Likewise, the first gear and the second gear can both be gear 1. In this way, the first vent structure 140 is provided on the rack structures 100 of the two gears, which better reduces the precision requirement for the gears. With a proper distance between gear shafts being set, both the first gear and second gear deform in an axial center direction after the gears mesh. As such, while a gear rotates one revolution, the gear always remains a pressed state with the other gear, thereby ensuring smooth and accurate transmission.

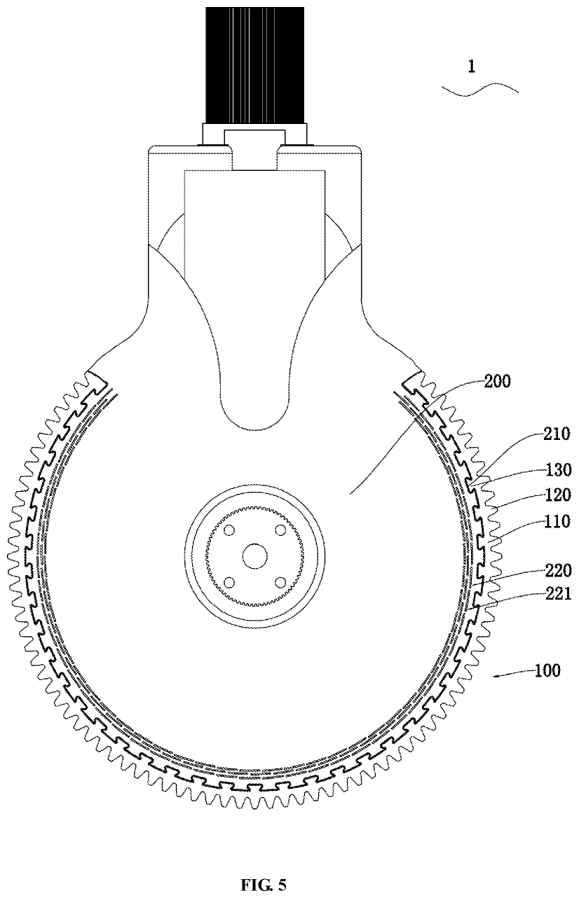

Furthermore, as shown in FIG. 5, a surface of the gear base 200 which adjacent to the connection portion 210 is provided circumferentially with a second vent structure 220, and the second vent structure 220 includes a plurality of discontinuous second vents 221.

The shape of the second vents 221 can be any one of a circle, a rectangle, an arc, an oval shape or a profiled shape. Specifically, the profiled shape refers to an irregular closed shape, such as an asymmetric closed shape, or a closed shape with four sides which are different in length and not parallel to one another, and other irregular cases, which are not limited in the embodiments of the present invention. In the present embodiment, the second vent 221 is rectangular.

Furthermore, several layers of second vent structures 220 can be arranged in a radial direction of the gear base 200 toward the connecting portion 210. In the present embodiment, the second vent structure 220 is preferably a three-layer arrangement structure, which ensures the size for mutual pressure when the gears mesh, and ensures smooth transmission.

In the embodiment of the present invention, the second vents 221 in adjacent layers of the second vent structures 220 can be staggered. The staggered second vents 221 can make the gear base 200 more stable.

Preferably, each of the second vents 221 penetrates the gear base 200 in a thickness direction of the gear base 200. In another embodiment, the second vent can also be a blind hole provided on the gear base and does not penetrate the gear base.

In the present embodiment, as shown in FIG. 5, the gear base 200 can be made of a flexible material, which can reduce the weight of the transmission structure and lower the overall load, but cannot reduce the working capability of the whole structure. Meanwhile, the rack structure 100 can be made of a metallic material or a wearable non-metallic material, i.e., made of a hard material, so that the wear resistance of the gear structure is enhanced. Since the gear base is made of a relatively light-weighted flexible material, the weight of the transmission mechanism does not substantially increase.

In the present embodiment, the rack structure 100 is not provided with the first vent structure 140, and instead, the gear base 200 made of a flexible material is provided with the second vent structure 220, which can also ensure stability of meshing transmission in a case where the precision of the gears in the gear transmission mechanism is not high. Specifically, the gear transmission mechanism (not shown) generally includes a first gear and a second gear that mesh with each other. One of the first gear and the second gear can be gear 1, or both of them can be gear 1. For example, in a case where the first gear is gear 1, when the second gear meshes with the first gear, while the teeth on the second gear mesh with tooth grooves on the first gear at corresponding positions, although the rack structure 100 is made of a hard material, the teeth of the second gear will press the second vent structure 140 on the gear base 200 because the gear base 200 is made of the flexible material, thereby ensuring the stability of the meshing. In a case where the teeth on the second gear and teeth on the first gear do not have a high precision or do not precisely correspond to one another upon meshed connection, since the second vent structure 220 can be pressed upon meshing, a stable pressed state can be always maintained between the first gear and the second gear, and the stability and accuracy of the gear transmission can be ensured.

Specifically, a meshing radial length of the first gear and the second gear can be set to be slightly larger than a distance between the two transmission shafts, and a distance difference is generated between the two. When the first gear meshes with the second gear, the teeth on the second gear will press the second vent structure 220 on the first gear, so that a compression distance of the second vent structure 220 can offset the above-mentioned distance difference, thereby ensuring the stability of the meshing.

Likewise, the first gear and the second gear can both be gear 1. In this way, the first vent structure 140 is provided on the gear bases 200 of the two gears, which reduces the precision requirement for the gears more. With a proper distance between gear shafts being set, both the first gear and second gear deform in an axial center direction after the gears mesh. As such, while a gear rotates one revolution, the gear always remains a pressed state with the other gear, thereby ensuring smooth and accurate transmission.

In the embodiment of the present invention, a total radial compression amount of the first vent 141 (or the second vent 221) is 0.1 mm to 1 mm. Depending on the processing accuracy and installation manner of the gear, the total radial compression amount of the first vent 141 (or the second vent 221) might also be larger when the gears mesh, which is not limited in the embodiment of the present invention. Specifically, in the embodiment of the present invention, the total radial compression amount of the first vent 141 (or the second vent 221) can be 0.2 mm, or 0.5 mm. With a proper distance between gear shafts being set, the gear provided with the first vent 141 (or the second vent 221) deforms 0.2 mm or 0.5 mm in the axial center direction after the gears mesh.

As such, while a gear rotates one revolution, the gear always remains a pressed state with the other gear, thereby ensuring smooth and accurate transmission, and thereby substantially reducing the precision requirement of the gears and reducing the mounting difficulty. The original precision requirement is reduced from +/−0.005 mm to +/−0.15 mm.

Likewise, in another embodiment, both the rack structure and gear base can be made of a flexible material, and meanwhile the rack structure is provided with the first vent structure and the gear base is provided with the second vent structure, which more apparently reduces the weight of the transmission structure, further reduces the overall load, and further reduce the precision requirement for the gears.

The rack structure 100 provided by the present invention can be directly detachably mounted on the gear base 200 through engagement and disengagement of the engaging portion 130 and the connecting portion 210 on the gear base 200, so that the rack structure 100 can be assembled quickly. Once the teeth 120 on the rack structure 100 wear, it is feasible to directly replace the rack structure, without replacing the gear base, thereby ensuring normal production of the production line and guaranteeing the service life of the whole gear base. Furthermore, it is possible to dispose the first vent structure 140 circumferentially on the rack body 110, thereby ensuring stability of meshing transmission even in a case where the precision of the gears in the gear transmission mechanism is not high. Likewise, it is possible to dispose the second vent structure 220 circumferentially on the gear base 200, thereby guaranteeing the stability of meshing transmission while reducing the precision requirements for gears.

It should be understood that although the present specification is described based on embodiments, not every embodiment contains only one independent technical solution. Such a narration way of the present specification is only for the sake of clarity. Those skilled in the art should take the present specification as an entirety. The technical solutions in the respective embodiments can be combined properly to form other embodiments which can be understood by those skilled in the art.

A series of the detailed descriptions set forth above is merely specific description of feasible embodiments of the present invention, and is not intended to limit the protection scope of the present invention. Equivalent embodiments or modifications made within the spirit of the present invention shall fall within the protection scope of the present invention.

1. A rack structure, wherein the rack structure comprises a rack body, a plurality of teeth formed on an outer side of the rack body, and an engaging portion formed on an inner side of the rack body, the engaging portion being shaped to engage with a connecting portion at an outer edge of a gear base; the rack structure is detachably mounted on the gear base through engagement or disengagement of the engaging portion and the connecting portion.

2. The rack structure according to claim 1, wherein the engaging portion is configured as a plurality of protrusions spaced apart from one another, and the connecting portion is configured as grooves disposed at positions corresponding to the protrusions; when the rack structure is mounted on the gear base, the protrusions are snap-fitted into the grooves.

3. The rack structure according to claim 1, wherein the rack structure is configured as a circular arc shape, and disposed around partial outer edge of the gear base.

4. The rack structure according to claim 1, wherein the rack structure is configured as a circular ring shape, and disposed around the whole outer edge of the gear base.

5. The rack structure according to claim 1, wherein a surface of the rack body which adjacent to the engaging portion is provided circumferentially with a first vent structure, and the first vent structure comprises a plurality of discontinuous first vents.

6. The rack structure according to claim 5, wherein the shape of the vents is configured as one of a circle, a rectangle, an arc, an oval shape and a profiled shape.

7. The rack structure according to claim 5, wherein several layers of the first vent structures are arranged in a radial direction of the rack body toward the engaging portion.

8. A gear, wherein the gear comprises a gear base and the rack structure according to claim 1.

9. The gear according to claim 8, wherein a surface of the gear base which adjacent to the connection portion is provided circumferentially with a second vent structure, and the second vent structure includes a plurality of discontinuous second vents.

10. A gear transmission mechanism, wherein the gear transmission mechanism comprises a first gear and a second gear which mesh each other, and one of the first gear or second gear is the gear according to claim 8.
